(19) United States
(12) Patent Application Publication
(10) Pub. No.: US 2022/0092403 A1
(43) Pub. Date: Mar. 24, 2022

(54) DIALOG DATA PROCESSING

(71) Applicant: INTERNATIONAL BUSINESS MACHINES CORPORATION, ARMONK, NY (US)

(72) Inventors: Zhuoxuan Jiang, Shanghai (CN); Lijun Mei, Beijing (CN); JIAN Wang, Beijing (CN); Zi Ming Huang, Beijing (CN)

(21) Appl. No.: 17/024,788

(22) Filed: Sep. 18, 2020

(51) Int. Cl. G06N 3/08; G06F 40/40; H04L 12/58

(52) U.S. Cl. CPC G06N 3/08; H04L 51/02; G06F 40/40

(57) ABSTRACT

A method, system, and computer program product processes dialog data. The method includes obtaining dialog data including heterogeneous data items. The method includes generating a heterogeneous network based on the dialog data. The heterogeneous network includes two or more bipartite subnetworks representing the relationship of the data items in the dialog data. The nodes of the two or more bipartite subnetworks correspond to the data items in the dialog data. The method includes determining node representations for the nodes in the heterogeneous network through representation learning.

### BACKGROUND

The present invention relates to the field of data processing, and more specifically, to a method, system and computer program products for processing dialog data.

A dialogue system (e.g., a conversational computing system, a chatbox system, a digital assistant, etc.) is a computer system that may employ artificial intelligence (AI) and/or natural language processing (NLP) to facilitate human-computer interaction. For example, the dialog system supports one or more types of dialog with a user, including but not limited to, responding to customer service inquiries regarding a product or service, guiding purchases by customers, responding to internal queries within an organization, assisting users in navigating a website, providing technical support, providing personalized service, training or educating the user, etc.

Dialogue systems employ one or more of text, speech, graphics, haptics, gestures, and other modes for communication on both the input and output channel. In learning-based dialog systems, it is important to model dialog data and obtain representations for sub-task learning.

### SUMMARY

According to one embodiment of the present invention, there is provided a computer-implemented method. The method comprises obtaining dialog data. The dialog data includes heterogeneous data items. The method comprises generating a heterogeneous network based on the dialog data. The heterogeneous network comprises two or more bipartite subnetworks representing the relationship of the data items in the dialog data. The nodes of the two or more bipartite subnetworks correspond to the data items in the dialog data. The method comprises determining node representations for the nodes in the heterogeneous network through representation learning. In other embodiments, a system and a computer program product are disclosed.

Other embodiments and aspects, including but not limited to, computer systems and computer program products, are described in detail herein and are considered a part of the claimed invention.

These and other features and advantages of the present invention will be described, or will become apparent to those of ordinary skill in the art, in view of the following detailed description of the example embodiments of the present invention.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node, in accordance with the exemplary embodiments.

FIG. 2 depicts a cloud computing environment, in accordance with the exemplary embodiments.

FIG. 3 depicts abstraction model layers, in accordance with the exemplary embodiments.

FIG. 4 depicts an example dialog system, in accordance with the exemplary embodiments.

FIG. 5 depicts a schematic diagram for an example system for processing dialog data, in accordance with the exemplary embodiments.

FIG. 6 depicts a schematic diagram for a system for processing dialog data, in accordance with the exemplary embodiments.

FIG. 7 depict a flow chart of a method for processing dialog data, in accordance with the exemplary embodiments.

FIG. 8A depicts an example dialog data, in accordance with the exemplary embodiments.

FIG. 8B depicts corresponding bipartite subnetworks for the example dialog data shown in FIG. 8A, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION

Some embodiments will be described in more detail with reference to the accompanying drawings, in which the embodiments of the present disclosure have been illustrated. However, the present disclosure may be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that may be rapidly provisioned and released with minimal management effort or interaction with a provider of the service. This cloud model may include at least five characteristics, at least three service models, and at least four deployment models.

Characteristics are as follows:

On-demand self-service: a cloud consumer may unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities may be rapidly and elastically provisioned, in some cases automatically, to quickly scale out and rapidly released to quickly scale in. To the consumer, the capabilities available for provisioning often appear to be unlimited and may be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage may be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which may include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

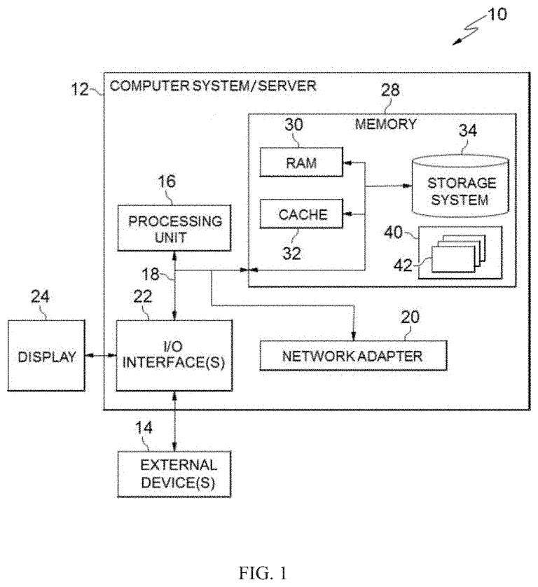

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 may include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication may occur via Input/Output (I/O) interfaces 22. Still yet, computer system/server 12 may communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

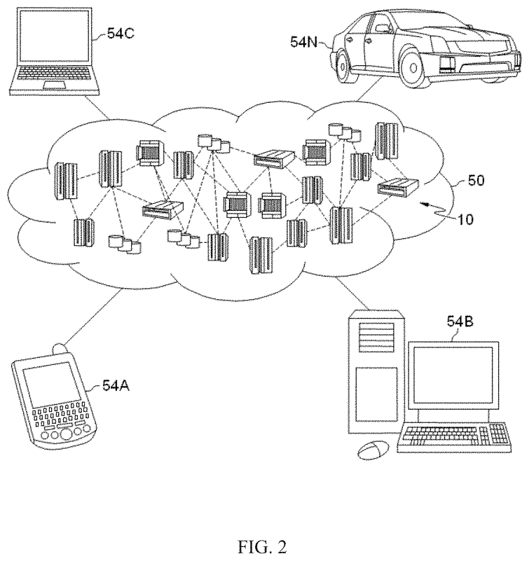

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer MB, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 may communicate with any type of computerized device over any type of network and/or network addressable connection (e.g., using a web browser).

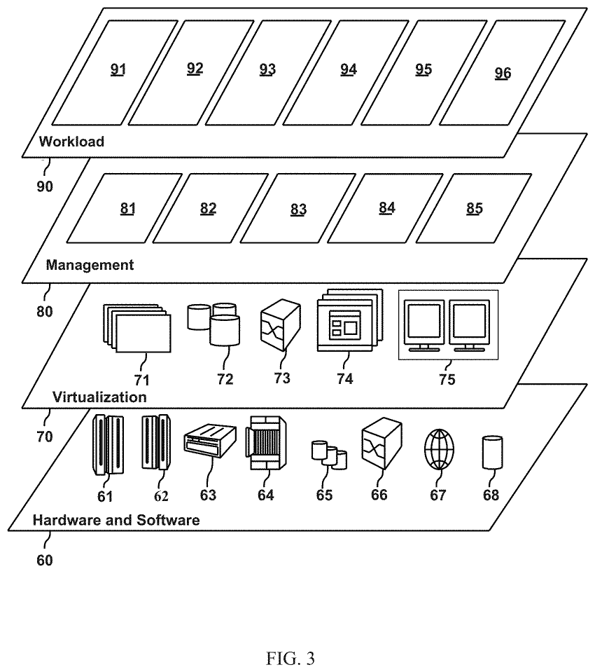

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

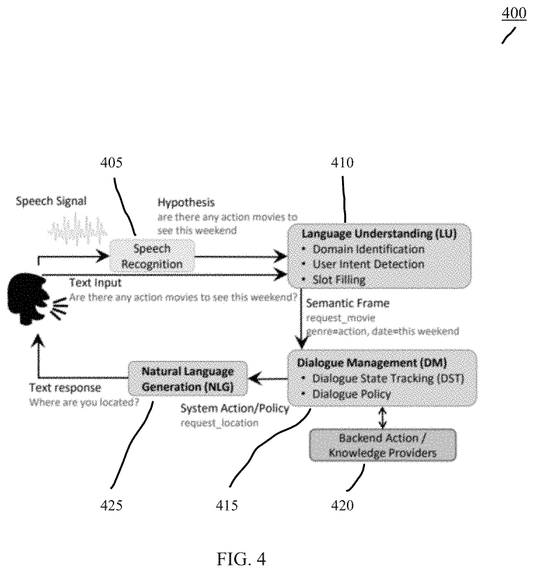

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dialog data processing 96. Hereinafter, reference will be made to FIGS. 4-7 to describe details of the dialog data processing 96.

In learning-based dialog systems, it is important to model dialog data and obtain representations for sub-task learning. Dialog data contains rich heterogeneous kinds of information, such as intent, entity, state, act, word, utterance, textual sequence and so on. At the task level within a dialog system, different tasks need different kinds of data. For example, the task of intent classification requires intent labels and utterances data, while entity recognition requires more entity label information. At system level, different kinds of dialog systems for multi-domains need different data. They may suffer from expensive cost of modeling the data for each sub-task and system.

FIG. 4 depicts an example dialog system 400 in which embodiments of the present invention may be implemented. A typical activity cycle in a dialog system contains the following phases. First, for recognizing and managing user input 405, dialog system implements a recognizer or decoder (not shown) for converting user speech into plain text through one or more of an automatic speech recognizer, a gesture recognizer, and a handwriting recognizer. The dialog system may also implement additional or alternate types of receivers and converters for converting user communication into a format within user input that may be processed by the dialog system.

The plain text is analyzed by a natural language understanding unit (NLU) 410. The NLU unit 410 performs domain identification, user intent detection and slot filing. The semantic information is analyzed by a dialog manager 415. The dialog manager 415 keeps the history and state of the dialog (dialog state tracking) and manages the general flow of the conversation according to a dialog policy. The dialog manager 415 contacts one or more task managers 420, that have knowledge of the specific task domain. The dialog manager's 415 output is then provided to a natural language generation unit 425 to produce text response or audio response to the user.

As mentioned above, the goal of natural language understanding unit 425 may be to extract three things from the user's utterance. The first task is domain classification. The second task is user intent detection, also known intent classification, which classifies user utterances into previously defined intent categories according to the domains and intents involved in the user utterances. The third task is slot filling, which extracts the particular slot and fillers that the user intends the system to understand from their utterance with respect to their intent.

For example, for an utterance “How long to drive to the nearest cafe?”, the matching intent may be “navigation.time.closest”. For another utterance “Give me directions to a cafe”, the matching intent may be “nagivation.direction”. Each intent has a set of fields or so-called slots that needs to be filled in to execute the user request. For the intent “nagivation.direction”, the system 400 needs to know where the user wants to go and from where the user wants to go. There would be two slots like FROM and TO. The slots would be extracted from the user utterance.

In machine learning, representation learning is a set of techniques that allows a system to automatically discover the representations needed for feature detection or classification from raw data. This replaces manual feature engineering and allows a machine to both learn the features and use them to perform a specific task. To learn each task of a dialog system, different input data are needed, and the representation learning methods are various and specific due to the different tasks.

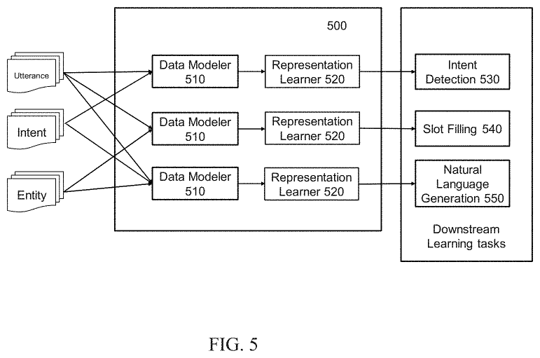

FIG. 5 depicts a schematic diagram for an example system 500 for processing dialog data. The system 500 includes a plurality of data modelers 510 for modeling dialog data and corresponding representation learners 520 for learning representations for different tasks. Although the system 500 is shown with three data modelers 510 and three corresponding representation learners 520, the exemplary embodiments may utilize any number of data modelers 510 and representation learners 520.

As shown in FIG. 5, for the intent detection task 530, utterances and data labeled with “intent” would be input data, and the data modeler 510 and representation learner 520 may be intent detection specific modules. For the slot filling task 540, utterances and data labeled with “entity” would be input data and the data modeler 510 and representation learner 520 may be slot filling specific modules. For the natural language generation task 550, utterances, data labeled with “intent” and data labeled with “entity” may be input data. And the data modeler 510 and representation learner 520 may be natural language generation specific modules.

Furthermore, for the task of intent detection, word embedding techniques may be used for deep learning. Word embeddings are a type of word representation that allows words with similar meaning to have a similar representation. Word embeddings are a class of techniques where individual words are represented as real-valued vectors in a predefined vector space. Each word is mapped to one vector and the vector values are learned in a way that resembles a neural network, and hence the technique is often lumped into the field of deep learning. For the task of slot filling, there are also embeddings to be performed. For the task of natural language generation, the encoder may convert each word token to a word embedding. Then these word embeddings are combined by a neural architecture to create a hidden state that describes the whole input sequence. Under the context of the present disclosure, “embedding” is a type of “representation”, referring to the technique of translating high-dimensional vectors to a relatively low-dimensional space. Embeddings make it easier to do machine learning on large inputs like sparse vectors representing words. Ideally, the embedding captures some of the semantics of the input by placing semantically similar inputs close together in the embedding space.

Considering that similar data may have been used as input for different tasks and embedding techniques are needed for those tasks, a novel method, system and computer program product is proposed according to embodiments of the present invention to model heterogeneous dialog data for information reuse and cost alleviation.

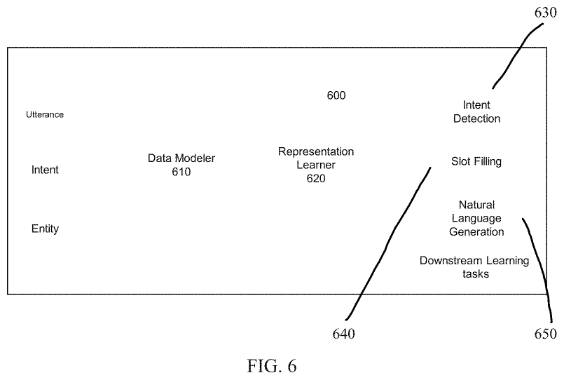

FIG. 6 depicts an example system 600 for processing dialog data according to an embodiment of the present invention. It is to be understood that the structure and functionality of the system 600 are described only for the purpose of illustration without suggesting any limitations as to the scope of the present disclosure.

As shown in FIG. 6, the system 600 includes a data modeler 610 and a representation learner 620.

According to an embodiment of the present invention, the dialog data with heterogeneous data items is input into data modeler 610, and the data modeler 610 establishes a heterogeneous network based on the dialog data. The dialog data may contain rich heterogeneous kinds of information, such as intent, entity, state, act, word, utterance, textual sequence and so on. For the sake of simplicity, only utterance, intent and entity are shown in FIG. 6 as examples of heterogeneous kinds of dialog data. It should be understood that any other types of data may be processed according to embodiments of the present invention.

Different bipartite subnetworks may be established representing the different relationships between the data items in the dialog data. In the mathematical field of graph theory, a bipartite graph (or bigraph) is a graph whose vertices (also referred as “nodes” herein) may be divided into two disjoint and independent sets U and V such that every edge connects a vertex in U to one in V. Vertex sets U and V are usually called the parts of the graph. The bipartite subnetworks may include a word to word network, a word to utterance subnetwork or a word to label subnetwork. For example, in the word to utterance bipartite subnetwork, one set of vertices are words and the other set of vertices are utterances. In the word to label bipartite subnetwork, one set of vertices are words and the other set of vertices are labels.

Each node of the bipartite subnetworks may correspond to a data item in the dialog data. The bipartite subnetworks may share nodes corresponding to the data items and a heterogeneous network would be established by combining those two or more bipartite subnetworks.

The heterogeneous network is then provided to the representation learner 620 and node representations are learned for the nodes in the heterogeneous network. Any appropriate representation learning techniques may be used here to learn the node representations. For example, node representations may be learned on the heterogeneous network with a graph neutral network algorithm. Graph neural network (GNN) is a type of neural network which directly operates on the Graph structure. A typical application of GNN is node classification or node representation. The nodes in the graph may be associated with a label. Given a partially labeled graph, the goal is to leverage these labeled nodes to predict the labels of the unlabeled. It learns to represent each node with a dimensional vector (state) which contains the information of its neighborhood. The outputs from the system 600 may subsequently be fed into downstream learning tasks including an intent detection task 630, a slot filling task 640, and a natural language generating task 650.

According to an embodiment of the present invention, the graph neutral network algorithm may be implemented with a negative sample method by optimizing parameters in an objective function, and the objective function is a sum of two or more objective functions corresponding the two or more bipartite subnetworks in the heterogeneous network respectively.

According to embodiments of the present invention, the learned node representations are then provided to different downstream learning tasks to learn models for the respective tasks. For example, the respective learning tasks may include intent detection, slot filing, and natural language generation. It is to be understood that the intent detection, slot filling, and natural language generation are described here merely as examples of learning tasks without any limitation. Any other learning task may also leverage the learned node representations according to embodiments of the present invention. Any appropriate model learning methods may be used to obtain the models from the node representations.

With the system described above according to an embodiment of the present invention, there is no need to learn specific data representations for different tasks and different domains multiple times. And the learning representations can be shared between different tasks and different dialog domains. Also, the system would be scalable to utilize heterogeneous information, like semantics and act information. It would be flexible to various quantity of information, e.g. semi-supervised learning with ranging from 0 to 100% labels.

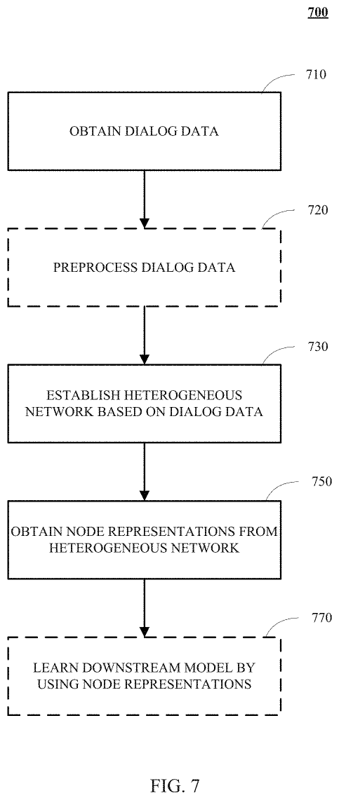

Reference is now made to FIG. 7, which depicts a flow chart of a method 700 for processing dialog data according to an embodiment of the present invention. For example, the method 700 may be implemented by the computer system/server 12 of FIG. 1. It is to be understood that the method 700 may also comprise additional blocks (not shown) and/or may omit the illustrated blocks. The scope of the present disclosure described herein is not limited in this aspect.

At block 710, the data modeler obtains dialog data. The dialog data includes heterogeneous data items. For example, the dialog data may contain rich heterogeneous kinds of information, such as intent, entity, state, act, word, utterance, textual sequence and so on.

At block 730, the data modeler generates or establishes a heterogeneous network based on the dialog data. The heterogeneous network may comprise two or more bipartite subnetworks.

According to an embodiment of the present invention, different bipartite subnetworks may be established representing the different relationship between the data items in the dialog data. Each node of the bipartite subnetworks may correspond to a data item in the dialog data. The bipartite subnetworks may share nodes corresponding to the data items and a heterogeneous network would be formed by combining those two or more bipartite subnetworks.

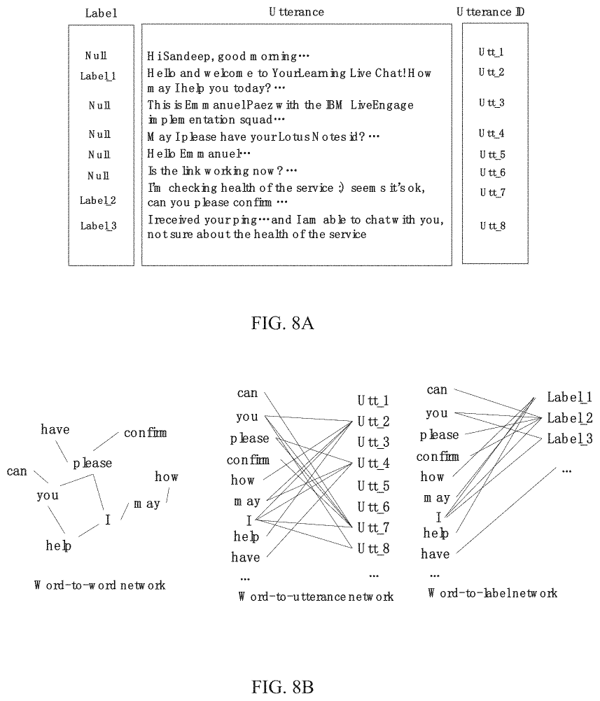

FIG. 8A depicts an example dialog data and FIG. 8B depicts corresponding bipartite subnetworks for the example dialog data. As shown in FIG. 8A, the dialog data includes dialog text and some labels for the text. For example, “Label_1” may refer to “opening”, ““Label_2” may refer to “request”, “Label_3” may refer to “statement”. Utterance IDs may be assigned to the utterances in the dialog data. Different bipartite subnetworks may be established accordingly, including a word to word network, a word to utterance subnetwork, and a word to label subnetwork, which show the relationship between word to word, word to utterance, word to label respectively. For the sake of clarity, those bipartite subnetworks are shown separately in FIG. 8B. A heterogeneous network would be established by combining those bipartite subnetworks. In the heterogeneous network including those bipartite subnetworks, same data item would be represented by a same node in the network. For example, for the node representing word “you”, in the heterogeneous network, it will have edges to the node for words “can”, “help”, and “please”, have edges to the nodes for utterances “Utt_2”, “Utt_7” and “Utt_8”, and have edges to the nodes for “label_2” and “label_3”.

Back to FIG. 7, in step 750, the representation learner determines or obtains node representation for the nodes in the heterogeneous network. Any appropriate representation learning techniques may be used to learn the node representations. For example, node representations may be learned on the heterogeneous network with a graph neutral network algorithm. According to an embodiment of the present invention, the graph neutral network algorithm may be implemented with a negative sample method by optimizing parameters in an objective function, and the objective function is a sum of two or more objective functions corresponding the two or more bipartite subnetworks in the heterogeneous network respectively.

According to embodiment of the present invention, after obtaining the dialog data, at block 720 the dialog data may be pre-processed by a data cleaner (not shown in FIG. 6). Data cleaning is the process of preparing data for analysis by removing or modifying data that is incorrect, incomplete, irrelevant, duplicated, or improperly formatted. Data cleaning is finding a way to maximize a data set's accuracy without necessarily deleting information. There are several methods for cleaning data depending on how it is stored along with the answers being sought. Data cleaning includes actions such as fixing spelling and syntax errors, standardizing data sets, and correcting mistakes such as empty fields, missing codes, and identifying duplicate data points. The data cleaner may use any appropriate cleaning techniques such as tokenizing, stemming, segmenting, formatting, etc. to process the dialog data.

According to embodiments of the present invention, at block 770, the learned node representations may be used as data representations of the data items in the dialog data to perform downstream model learning. For example, the node representations may be used to represent utterances and other elements in the dialog data to learn downstream models, like intent detection, slot filling, natural language generation, etc.

As mentioned above, any appropriate representation learning techniques may be used here to learn the node representations. Below is an example graph neutral network algorithm with negative sampling method according to an embodiment of the present invention would be described.

An objective function of the representation learning of the heterogeneous network may be shown as below using the following equations:

$$\begin{matrix}O = {\sum }_{i = 1}^{N} {W}_{i} {O}_{i} \\ in which & ( Equation 1 ) \\ {O}_{i} = - {\sum }_{( j , k ) ∈ {E}_{i}} {w}_{jk} log p ( {v}_{j} \vert {v}_{k} ) & ( Equation 2 ) \\ p ( {v}_{j} \vert {v}_{k} ) = \frac{exp ( {\vec{u}}_{j}^{T} \cdot {\vec{u}}_{k} ) }{{\sum }_{{j}^{′} ∈ A} exp ( {\vec{u}}_{{j}^{′}}^{T} \cdot {\vec{u}}_{k} )} & ( Equation 3 )\end{matrix}$$

wherein,
O is the objective function;
N is the number of bipartite graphs;
Wi is the weight of the i-th bipartite graph;
Oi is the i-th objective function corresponding to i-th bipartite graph;
Ei is the set of edges in the i-th bipartite graph;
p is a probability function;
vi is the i-th node of a bipartite graph;
vk is the k-th node of a bipartite graph; [symbol]
is the vector representation of the j-th node in graph.

The following algorithm would be used to optimize the parameters in above objective function:

### Algorithm: Node Representation Learning

Data: Gi (the i-th bipartite graph), number of samples T, number of negative samples K
Result: node embeddings
While iter <=T do

while i<=N do

sample an edge from Ei and draw K negative edges, and update the node embeddings;

### End

With above illustrated node representation learning algorithm, the parameters of the objective function of the representation learning would be optimized and node representations for the nodes in the heterogeneous network would be obtained.

With the method described above according to an embodiment of the present invention, the learned representations can be shared between different tasks and different dialog domains and there is no need to learn specific data representations for different tasks and different domains multiple times. The system would be scalable to utilize heterogeneous information, like semantics and act information. It would be flexible to various quantity of information, e.g. semi-supervised learning with ranging from 0 to 100% labels.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining, by one or more processors, dialog data, the dialog data including heterogeneous data items;
generating, by the one or more processors, a heterogeneous network based on the dialog data, wherein the heterogeneous network comprises two or more bipartite subnetworks representing a relationship of the data items in the dialog data, and nodes of the two or more bipartite subnetworks corresponding to the data items in the dialog data; and
determining, by the one or more processors, node representations for the nodes in the heterogeneous network through representation learning.

2. The computer-implemented method of claim 1, further comprising:
obtaining, by the one or more processors, a downstream model by using the determined node representations as data representations of the data items in the dialog data to perform model learning.

3. The computer-implemented method of claim 2, wherein the downstream model includes a model for a task selected from the group of: intent detection, slot filing, and natural language generation.

4. The computer-implemented method of claim 1, wherein the representation learning is a graph neutral network algorithm implemented on the heterogeneous network.

5. The computer-implemented method of claim 4, wherein the graph neutral network algorithm is implemented with a negative sample method by optimizing parameters in an objective function, wherein the objective function is a sum of two or more objective functions corresponding the two or more bipartite subnetworks in the heterogeneous network respectively.

6. The computer-implemented method of claim 1, wherein the heterogeneous data items include words, utterances, and labels, wherein the two or more bipartite subnetworks include word to word subnetwork, word to utterance subnetwork, and word to label subnetwork.

7. The computer-implemented method of claim 1, wherein the obtained dialog data are pre-processed by a data cleaner.

8. A system comprising:
a processing unit; and
a memory coupled to the processing unit and storing instructions thereon, the instructions, when executed by the processing unit, performing actions comprising:
obtaining dialog data, the dialog data including heterogeneous data items;
generating a heterogeneous network based on the dialog data, wherein the heterogeneous network comprises two or more bipartite subnetworks representing a relationship of the data items in the dialog data, and nodes of the two or more bipartite subnetworks correspond to the data items in the dialog data; and
determining node representations for the nodes in the heterogeneous network through representation learning.

9. The system of claim 8, wherein the actions further comprise:
obtaining a downstream model by using the determined node representations as data representations of the data items in the dialog data to perform model learning.

10. The system of claim 9, wherein the downstream model includes a model for a task selected from the group of: intent detection, slot filing, and natural language generation.

11. The system of claim 9, wherein the representation learning is a graph neutral network algorithm implemented on the heterogeneous network.

12. The system of claim 11, wherein the graph neutral network algorithm is implemented with a negative sample method by optimizing parameters in an objective function, wherein the objective function is a sum of two or more objective functions corresponding the two or more bipartite subnetworks in the heterogeneous network respectively.

13. The system of claim 8, wherein the heterogeneous data items include words, utterances, and labels, wherein the two or more bipartite subnetworks include word to word subnetwork, word to utterance subnetwork, and word to label subnetwork.

14. A computer program product being tangibly stored on a non-transient machine-readable medium and comprising machine-executable instructions, the instructions, when executed on a device, causing the device to perform actions comprising:
obtaining dialog data, the dialog data including heterogeneous data items;
generating a heterogeneous network based on the dialog data, wherein the heterogeneous network comprises two or more bipartite subnetworks representing a relationship of the data items in the dialog data, and nodes of the two or more bipartite subnetworks correspond to the data items in the dialog data; and
determining node representations for the nodes in the heterogeneous network through representation learning.

15. The computer program product of claim 14, wherein the actions further comprise:
obtaining a downstream model by using the determined node representations as data representations of the data items in the dialog data to perform model learning.

16. The computer program product of claim 15, wherein the downstream model includes a model for a task selected from the group of: intent detection, slot filing, and natural language generation.

17. The computer program product of claim 14, wherein the representation learning is a graph neutral network algorithm implemented on the heterogeneous network.

18. The computer program product of claim 17, wherein the graph neutral network algorithm is implemented with a negative sample method by optimizing parameters in an objective function, wherein the objective function is a sum of two or more objective functions corresponding the two or more bipartite subnetworks in the heterogeneous network respectively.

19. The computer program product of claim 14, wherein the heterogeneous data items include words, utterances, and labels, wherein the two or more bipartite subnetworks include word to word subnetwork, word to utterance subnetwork, and word to label subnetwork.

20. The computer program product of claim 14, wherein the obtained dialog data are pre-processed by a data cleaner.
